(19) United States
(12) Patent Application Publication
(10) Pub. No.: US 2009/0282420 A1
(43) Pub. Date: Nov. 12, 2009

(54) APPLICATION LINKAGE CONTROL APPARATUS AND APPLICATION LINKAGE CONTROL METHOD

(75) Inventors: Kazuhisa Fujita, Kawasaki (JP); Shoji Yamamoto, Kawasaki (JP); Yasuo Koike, Kawasaki (JP); Tamaki Tanaka, Kawasaki (JP); Kazuya Uesugi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/506,043

(22) Filed: Jul. 20, 2009

Related U.S. Application Data
(63) Continuation of application No. PCT/JP2007/053834, filed on Feb. 28, 2007.

(51) Int. Cl. G06F 9/54

(52) U.S. Cl. 719/314

(57) ABSTRACT

When a message is transmitted from a storing application of a process requesting server, a message queuing server stores the message in a queue. When storing the message in the queue, the message queuing server transmits information regarding this message to an extracting application of a process performing server, thereby controlling a linkage operation between the storing application of the process requesting server and the extracting application of the process performing server.

### CROSS-REFERENCE TO RELATED APPLICATION(S)

This application is a continuation of PCT international application Ser. No. PCT/JP2007/053834 filed on Feb. 28, 2007 which designates the United States, the entire contents of which are incorporated herein by reference.

### FIELD

The embodiments discussed herein are directed to an application linkage control program, an application linkage control method, and an application linkage control apparatus.

### BACKGROUND

Conventionally, in a distributed system for providing a service by coordinating a plurality of computers with each other, a technique called “message queuing” is used as a technology for linking operations among different application programs (hereinafter, referred to as “applications”) (for example, refer to Japanese Laid-open Patent Publication No. 09-167145). In this message queuing, messages to be transmitted and received among applications are exchanged via a storage area called queue.

FIG. 11 is a diagram for explaining conventional message queuing. As depicted in FIG. 11, in message queuing, a process-requesting-side application makes a request for performing a process by storing a message in a storage area called queue. On the other hand, a process-performing side application regularly refers to the queue at predetermined intervals to check whether any message is stored and, when it is stored, extracts the message and performs the process.

In this manner, with this message exchange by using a queue, messages can be transmitted and received asynchronously among applications. Even if a state can be assumed such that the connection may be temporarily broken, a message can be reliably sent from a process-requesting side to a process-performing side without taking any special measures for the applications.

However, in the conventional message queuing explained above, the process-performing-side application refers to the queue at predetermined intervals set in advance to perform the process. Therefore, a time lag occurs between the timing when a message is stored in the queue and the timing when the message is extracted therefrom, thereby disadvantageously causing process latency. For example, when a predetermined interval is set at one second, latency of one second at maximum will occur.

This problem of process latency in message queuing significantly hinders an increase in process performance of the distributed system.

### SUMMARY

According to an aspect of the invention, an application linkage control apparatus controls a linkage operation among applications by using a queue having accumulated therein messages transmitted and received asynchronously among the applications. The apparatus includes a message accumulating unit that accumulates a message transmitted from a transmission-source application in the queue; and an application linkage control unit that controls a linkage operation between the transmission-source application and a transmission-destination application by transmitting, to the transmission-destination application, information regarding the message accumulated in the queue by the message accumulating unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining the concept of application linkage control by a message queuing server according to an embodiment;

FIG. 2 is a functional block diagram of the configuration of the message queuing server according to the present embodiment;

FIG. 3 is a diagram of an example of messages stored in a queue;

FIG. 4 is a flowchart of the process procedure of the message queuing server according to the present embodiment;

FIG. 5 is a functional block diagram of the configuration of a computer that executes an application linkage control program according to the present embodiment;

FIG. 6 is a diagram of the configuration in the present embodiment;

FIG. 7 is a diagram of the configuration in a first embodiment;

FIG. 8 is a diagram of the configuration in a second embodiment;

FIG. 9 is a diagram of the configuration in a third embodiment;

FIG. 10 is a system configuration diagram when an application linkage control system of the present invention is applied to a stock exchange system; and

FIG. 11 is a diagram for explaining conventional message queuing.

### DESCRIPTION OF EMBODIMENTS

Preferred embodiments of the present invention will be explained with reference to accompanying drawings. Note in the embodiments that the case is explained in which the present invention is applied to a message queuing server that controls, in a distributed system, a linkage operation among applications by using a queue having accumulated therein messages transmitted and received asynchronously among the applications.

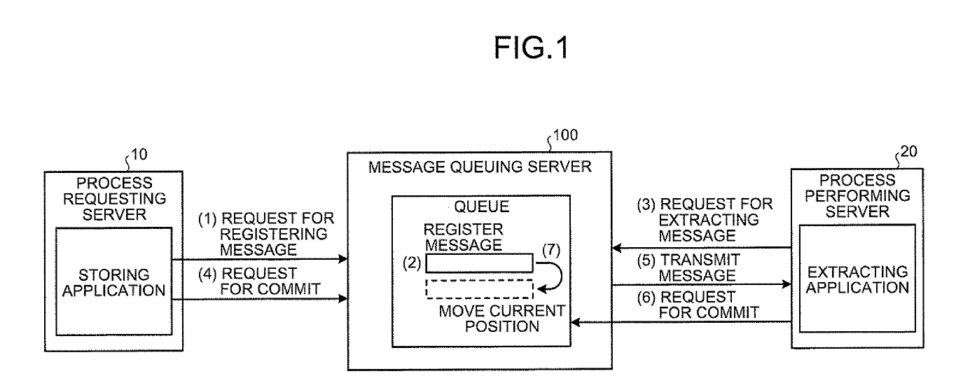

First, the concept of application linkage control by a message queuing server according to an embodiment is explained. FIG. 1 is a diagram for explaining the concept of application linkage control by a message queuing server according to the present embodiment. As depicted in FIG. 1, a message queuing server 100 according to the present embodiment is connected between a process requesting server 10 that achieves a predetermined task service by requesting a process performing server 20 to perform various task processes and the process performing server 20 that performs a process requested from the process requesting server 10, via a predetermined network not depicted.

In this configuration, a main feature of the present embodiment is as follows. When a message is transmitted from an application of the process requesting server 10, the message queuing server 100 according to the present embodiment stores the message in a queue. When storing the message in the queue, the message queuing server 100 transmits information regarding this message to an application of the process performing server 20, thereby controlling a linkage operation between the application of the process requesting server 10 and the application of the process performing server 20.

Specifically, as depicted in FIG. 1, when a message registration request is transmitted from the storing application of the process requesting server 10 (refer to (1) in FIG. 1), the message queuing server 100 according to the present embodiment registers a message transmitted together with the message registration request in a queue (refer to (2) in FIG. 1).

Then, when receiving a message extracting request from the process performing server 20 (refer to (3) in FIG. 1) the message queuing server 100 waits for commit information for requesting confirmation of a transaction process to be transmitted from the process requesting server 10. When the commit information is transmitted (refer to (4) “request for COMMIT” in FIG. 1), the message queuing server 100 immediately transmits the message registered in the queue to the process performing server 20 ((5) in FIG. 1).

Then, when the commit information is transmitted from the process performing server 20 (refer to (6) “request for COMMIT” in FIG. 1), the message queuing server 100 moves a current position in the queue where the message is to be extracted to a position where a message is to be registered next (refer to (7) in FIG. 1).

With this feature, the message queuing server 100 according to the present embodiment can solve process latency occurring from the time when a message is stored in the queue to the time when the message is extracted therefrom, thereby increasing process performance of a distributed system connected via the queue.

Also, the message queuing server 100 according to the present embodiment has another feature as follows. When a message is transmitted from the application of the process requesting server 10, the message queuing server 100 according to the present embodiment stores the message in a queue, with a predetermined item contained in the transmitted message being set as an index. When accepting designation of the item set as an index, the message queuing server 100 outputs a message corresponding to the designated item to a display device or the like.

With this feature, the message queuing server 100 according to the present embodiment does not require a special database for retaining processed messages, which is conventionally required, when reference to the processed messages is required. By using an index, the messages accumulated in the queue can be easily referred to. With this, it is possible to increase process performance when a process accompanied by reference to processed or unprocessed messages is to be performed.

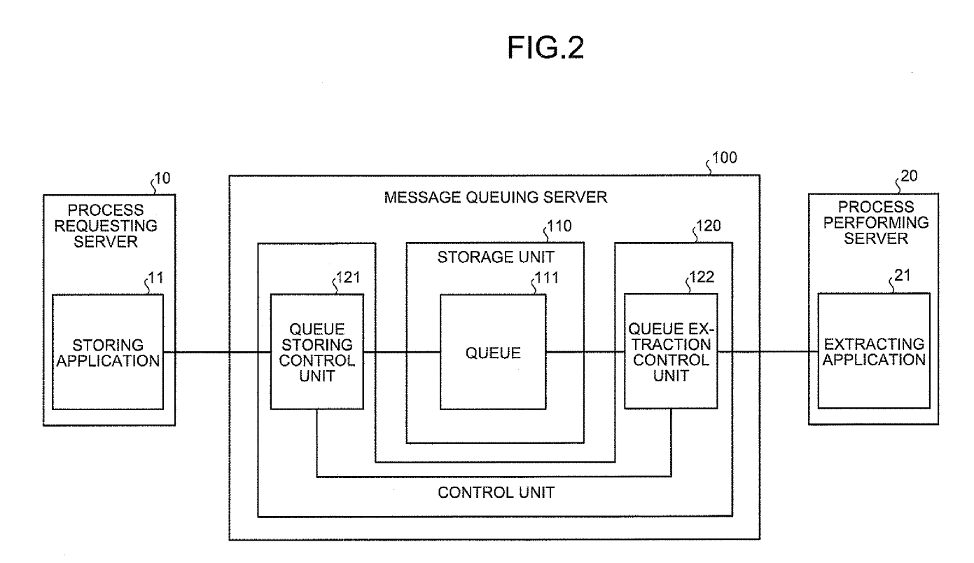

Next, the configuration of the message queuing server 100 according to the present embodiment is explained. FIG. 2 is a functional block diagram of the configuration of the message queuing server 100 according to the present embodiment. As depicted in FIG. 2, this message queuing server 100 is connected between the process performing server 20 and the process requesting server 10 via a network not depicted.

The process requesting server 10 achieves a predetermined task service by requesting the process performing server 20 that performs predetermined task processes to perform various task processes, and includes a storing application 11. The storing application 11 is an application for transmitting a message to the message queuing server 100 when a request for any of the various task processes is made.

The process performing server 20 performs the process requested from the process requesting server 10, and includes an extracting application 21. The extracting application 21 is an application for obtaining a message from the message queuing server 100 when any of the various task processes is performed.

The message queuing server 100 is a server that controls a linkage operation between the application of the process requesting server 10 and the application of the process performing server 20, and includes a storage unit 110 and a control unit 120.

The storage unit 110 stores various data and programs, and includes a queue 111, which is an example of a component regarding the present invention. Note that this storage unit 110 may be achieved by a memory or hard disk.

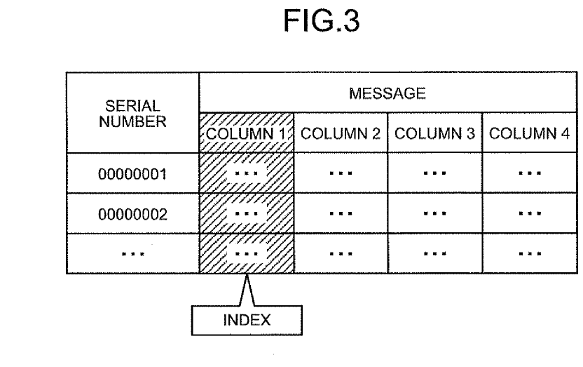

The queue 111 has accumulated therein messages transmitted and received asynchronously among applications. FIG. 3 is a diagram of an example of messages stored in the queue 111. Specifically, as depicted in FIG. 3, the queue 111 has serial numbers indicating the order of storing messages in the queue 111 and messages in association with each other.

Here, the messages stored in the queue 111 have a data structure with a predetermined number of items and, among these items, a predetermined item is set as an index. For instance, in the example depicted in FIG. 3, each message stored in the queue 111 is formed of four items “column 1”, “column 2”, “column 3”, and “column 4”, and “column 1” is set as an index.

Referring back to FIG. 2, the control unit 120 controls the entire message queuing server 100, and includes a queue storing control unit 121 and a queue extraction control unit 122, which are examples of components regarding the present invention.

The queue storing control unit 121 is a processing unit that stores a message transmitted from the process requesting server 10 in the queue 111. Specifically, when a request for registering a message is transmitted from the storing application 11 of the process requesting server 10 (request for COMMIT), the queue storing control unit 121 stores the message in the queue 111, with a predetermined item contained in the transmitted message being set as an index (refer to FIG. 3).

Here, with the queue storing control unit 121 setting an index for the message stored in the queue 111, the message exchanged between the process requesting server 10 and the process performing server 20 can be easily checked. Note that an item set as an index in a message is hereinafter referred to as an “index item”.

Then, for the messages stored in the queue 111, the queue storing control unit 121 takes serial numbers indicating the order of storing in the queue 111, provides them for each message (refer to FIG. 3), and then transmits commit information to the process requesting server 10 (return COMMIT). With this, a transaction process in the process requesting server 10 is completed.

After the foregoing process is completed, the queue storing control unit 121 reports the serial number provided to a message to the queue extraction control unit 122, which is explained further below. Here, with the queue storing control unit 121 reporting the serial number, a message corresponding to the serial number is extracted by the queue extraction control unit 122 from the queue 111, and is transmitted to the process performing server 20.

The queue extraction control unit 122 is a processing unit that extracts a message from the queue 111 and transmits the message to the process performing server 20. Specifically, when a message serial number is reported from the queue storing control unit 121, the queue extraction control unit 122 extracts a message associated with this serial number from the queue 111, and transmits the extracted message and its serial number to the extracting application 21 of the process performing server 20.

Then, when commit information indicating that a transaction process accompanied by a process of extracting a message stored in the queue 111 has been established is transmitted from the extracting application 21 of the process performing server 20 (request for COMMIT), the queue extraction control unit 122 moves a current position in the queue 111 where a message is to be extracted to a position where a message is to be registered next, and then transmits commit information to the process performing server 20 (return COMMIT). With this, a transaction process in the process performing server 20 is completed.

Also, when accepting designation of an index item from a user or the like via a message referring application not depicted, the queue extraction control unit 122 refers to the queue 111 to extract a message corresponding to the designated index item, and then outputs the message to a display device or the like not depicted. At this time, in the messages stored in the queue 111, an index item has already been set by the queue storing control unit 121 explained above. Therefore, the queue extraction control unit 122 can easily extract the designated message.

Here, the case has been explained in which the queue extraction control unit 122 refers to the queue 111 based on the index item to output a message. Alternatively, the queue 111 may be referred to by using an application for referring to messages with a function of accepting designation of an index item from a user or the like, thereby outputting a message.

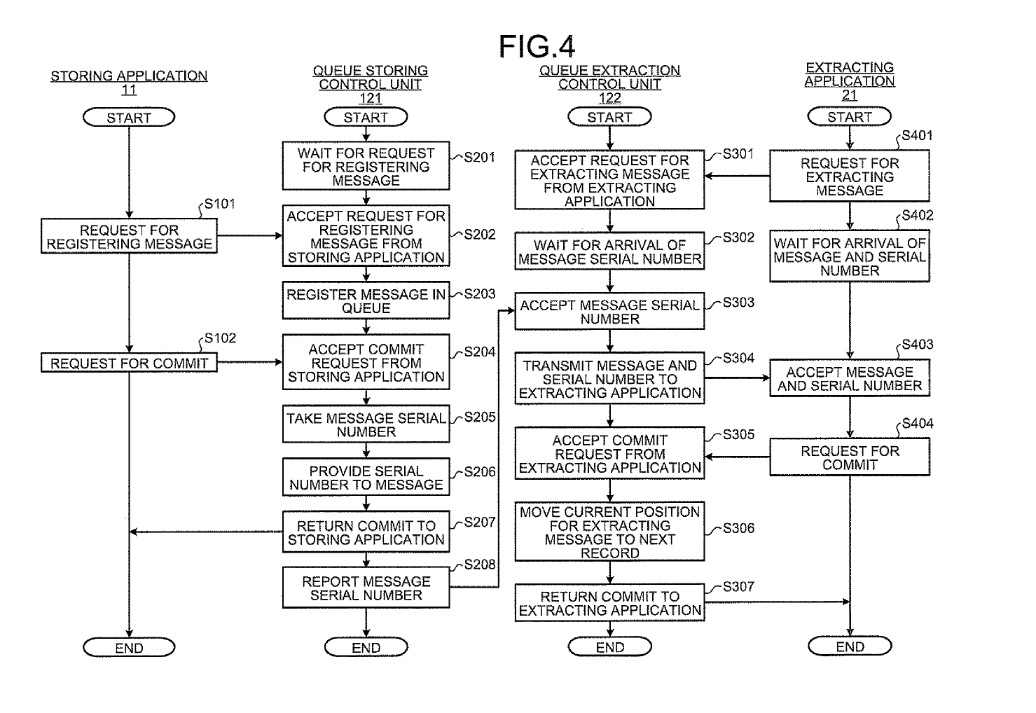

Next, the process procedure of the message queuing server 100 according to the present embodiment is explained. FIG. 4 is a flowchart of the process procedure of the message queuing server 100 according to the present embodiment.

As depicted in FIG. 4, in the message queuing server 100, the queue storing control unit 121 waits for a request for registering a message transmitted from the storing application 11 of the process requesting server 10 (Step S201). When a request for registering a message is transmitted (Step S101), the queue storing control unit 121 accepts this request (Step S202), and registers the registration-requested message in the queue 111 (Step S203).

On the other hand, when a request for extracting a message is transmitted from the extracting application 21 of the process performing server 20 (Step S401), the queue extraction control unit 122 accepts the request (Step S301) and waits for a serial number of the message transmitted from the queue storing control unit 121 to come (Step S302).

In this state, in the message queuing server 100, when COMMIT is requested from the storing application 11 of the process requesting server 10 (Step S102), the queue storing control unit 121 accepts this request (Step S204), takes a serial number for the message registered in the queue 111 (Step S205), provides the taken serial number to the message (Step S206), and then returns COMMIT to the storing application 11 (Step S207).

After returning COMMIT, the queue storing control unit 121 reports the message serial number to the queue extraction control unit 122 (Step S208).

When the message serial number is reported from the queue storing control unit 121, the queue extraction control unit 122 accepts this report (Step S303), extracts a message associated with the serial number from the queue 111, and transmits the extracted message and its serial number to the extracting application 21 of the process performing server 20 (Step S304).

In the process performing server 20, after transmitting a request for extracting a message (refer to Step S401), the extracting application 21 is in a state of waiting for a message and its serial number to come (Step S402).

Then, when a message and its serial number come from the queue extraction control unit 122 of the message queuing server 100, the extracting application 21 accepts these message and serial number (Step S403), and requests the queue extraction control unit 122 of the message queuing server 100 for COMMIT (Step S404).

Then, in the message queuing server 100, when COMMIT is requested, the queue extraction control unit 122 accepts this request (Step S305), moves a current position in the queue 111 where a message is to be extracted to a position of the next record (Step S306), and then returns COMMIT to the extracting application 21 of the process performing server 20 (Step S307).

As explained above, in the present embodiment, when a message is transmitted from the storing application 11 of the process requesting server 10, the queue storing control unit 121 stores the message in the queue 111. When the message is stored by the queue storing control unit 121 in the queue 111, the queue extraction control unit 122 transmits the message to the extracting application 21 of the process performing server 20, thereby controlling a linkage operation between the storing application 11 and the extracting application 21. With this, process latency occurring from the time when a message is stored in the queue 111 to the time when the message is extracted therefrom can be solved to increase process performance of a distributed system connected via the queue 111.

Also, in the present embodiment, after the message is stored by the queue storing control unit 121 in the queue 111, when commit information indicating that a transaction process accompanied by transmission of the message has been established is transmitted from the storing application 11 of the process requesting server 10, the queue extraction control unit 122 transmits the message to the extracting application 21 of the process performing server 20. With this, the transmission-destination application can be operated only when a transaction process by the transmission-source application has been successfully completed, thereby efficiently operating the transmission-destination application.

Furthermore, in the present embodiment, when a message is transmitted from the storing application 11 of the process requesting server 10, the queue storing control unit 121 stores the message in the queue 111, with a predetermined item contained in the transmitted message being set as an index, and the queue extraction control unit 122 transmits the message stored in the queue 111 to the extracting application 21 of the process performing server 20, thereby controlling a linkage operation between the storing application 11 and the extracting application 21. Also, when designation of the item set as an index is accepted from a user or the like, a message corresponding to the designated item is output to a display device or the like. With this, when reference to the processed messages is required, a special database for retaining these processed messages, which is conventionally required, is not required. By using an index, the messages accumulated in the queue 111 can be easily referred to. Thus, it is possible to increase process performance when a process accompanied by reference to processed or unprocessed messages is to be performed.

Still further, after the message is stored in the queue 111, the queue storing control unit 121 provides the message with a serial number indicating the order of storing in the queue 111. With this, processes regarding provision of serial numbers, which are conventionally performed individually when the transmission-source application transmits a message, can be unified, and a bottleneck due to exclusive control in discharging a serial number can be solved. Thus, process performance of the distributed system connected via the queue 111 can be further increased.

Still further, in the present embodiment, when a message accumulated in the queue 111 is extracted, the queue extraction control unit 122 may provide the message with a serial number indicating the order of storing in the queue 111. With this, when the frequency of storing a message in the queue 111 is higher than the frequency of extracting a message from the queue 111, a process regarding provision of a serial number can be performed at distributed timings, and process performance of the distributed system connected via the queue 111 can be further increased.

Note in the present embodiment that the case has been explained in which the queue storing control unit 121 provides a serial number to a message stored in the queue 111. Alternatively, when the queue extraction control unit 122 extracts a message accumulated in the queue 111, the queue extraction control unit 122 may provide the message with a serial number indicating the order of storing in the queue 111.

With this, when the frequency of storing a message in the queue 111 is higher than the frequency of extracting a message from the queue 111, a process regarding provision of a serial number can be performed at distributed timings. Thus, process performance of the distributed system connected via the queue 111 can be further increased.

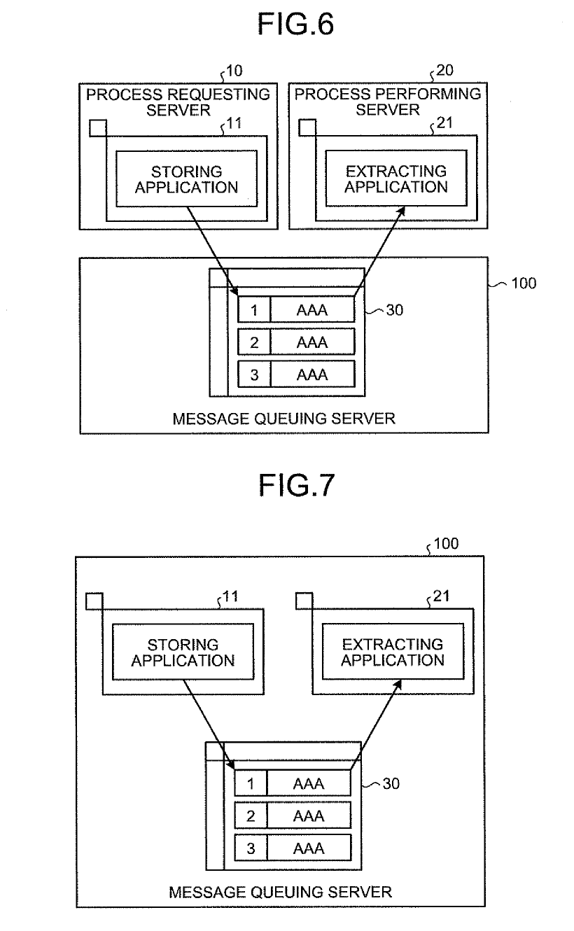

Still further, in the present embodiment, for convenience of explanation, the case has been explained in which one process requesting server 10 and one process performing server 20 are connected to the message queuing server 100 as depicted in FIG. 6 (FIG. 6 is a diagram of the configuration in the present embodiment). Alternatively, to the message queuing server 100, a plurality of process requesting servers 10 and the process performing servers 20 may be connected (for easy explanation, in FIG. 6, the control unit 120 and the storage unit 110 in FIG. 2 are collectively depicted as a message queuing unit 30).

Still further, in the present embodiment, the case has been explained in which the message queuing server 100 includes one queue 111. However, this is not meant to restrict the present invention, and the present invention can be similarly applied to the case in which the message queuing server includes a plurality of queues.

For example, when a plurality of process performing servers are connected to the message queuing server 100, a queue is assigned in advance to each process performing server, and when a request for registering a message is accepted, the queue storing control unit 121 distributes the message to a queue based on the transmission destination of the message.

Still further, in the present embodiment, the case has been explained in which the message queuing server 100 performs application linkage control. With the structure of the message queuing server 100 being achieved by software, an application-linkage control program having similar functions can be attained. Here, a computer that executes this application linkage control program is explained below.

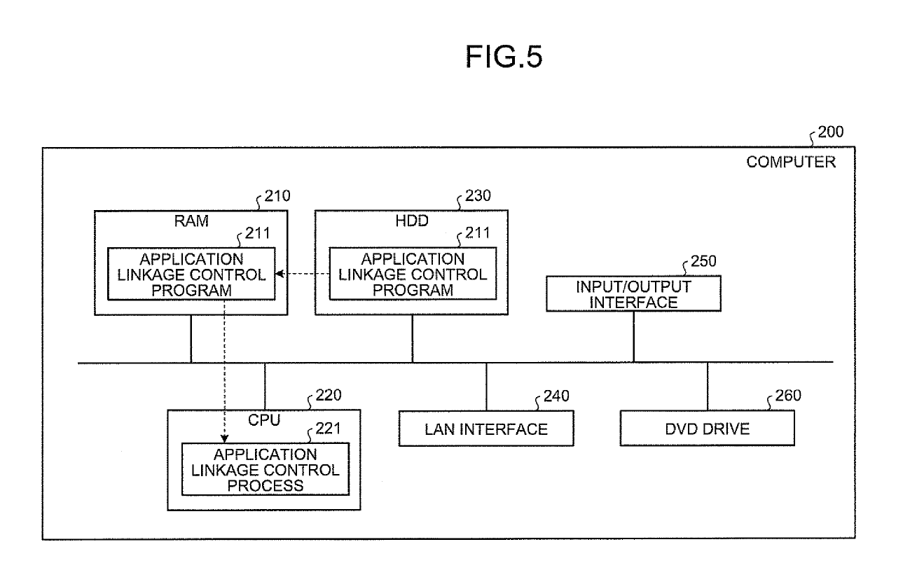

FIG. 5 is a functional block diagram of the configuration of a computer that executes an application linkage control program according to the present embodiment. As depicted in FIG. 5, a computer 200 includes a Random Access Memory (RAM) 210, a Central Processing Unit (CPU) 220, a Hard Disk Drive (HDD) 230, a Local Area Network (LAN) interface 240, an input/output interface 250, and a Digital Versatile Disk (DVD) drive 260.

The RAM 210 has stored therein programs and execution progress results of these programs and others. The CPU 220 is a central processing unit that reads a program from the RAM 210 for execution.

The HDD 230 is a disk device that has programs and data stored therein. The LAN interface 240 is an interface for connecting the computer 200 to another computer via a LAN.

The input/output interface 250 is an interface for connecting an input device, such as a mouse and keyboard, and a display device. The DVD drive 260 is a device that reads from and writes in a DVD.

An application linkage control program 211 executed on this computer 200 is stored in a DVD, and is read from the DVD by the DVD drive 260 to be installed on the computer 200.

Alternatively, the application linkage control program 211 is stored, for example, in a database in another computer system connected via the LAN interface 240, and is read from this database to be installed on the computer 200.

The installed application linkage control program 211 is then stored in the HDD 230, is read onto the RAM 210, and is then executed by the CPU 220 as an application linkage control process 221.

Still further, among the processes explained in the present embodiment, all or part of the processes explained as being automatically performed can be manually performed, or all or part of the processes explained as being manually performed may be automatically performed through a known method.

In addition, the process procedure, the control procedure, specific names, and information including various data and parameters explained in the specification and depicted in the drawings can be arbitrarily changed unless otherwise specified.

Still further, each component of each apparatus depicted is conceptual in function, and is not necessarily physically configured as depicted. That is, the specific patterns of distribution and unification of the components are not meant to be restricted to those depicted in the drawings. All or part of the components can be functionally or physically distributed or unified in arbitrary units according to various loads and the state of use.

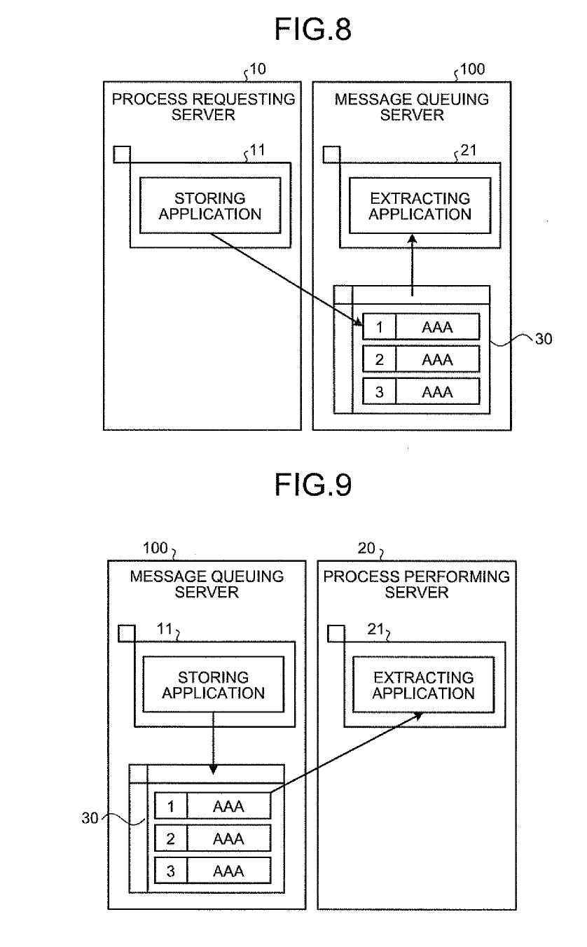

In the following, a specific example of distribution and unification is explained. FIG. 7 is a diagram of the configuration in a first embodiment. FIG. 8 is a diagram of the configuration in a second embodiment. FIG. 9 is a diagram of the configuration in a third embodiment.

For example, as depicted in FIG. 7, the message queuing server 100 may include the storing application 11 for storing a queue in the message queuing unit 30 and the extracting application 21 for extracting a process from the message queuing unit 30 (note in FIG. 7 that, for easy explanation, the control unit 120 and the storage unit 110 in FIG. 2 are collectively depicted as the message queuing unit 30).

Alternatively, as depicted in FIG. 8, the process requesting server 10 may be a physical server having the storing application 11 as explained in the embodiment above, and the message queuing server 100 may include the extracting application 21 for extracting a process from the message queuing unit 30 (note also in FIG. 8 that, for easy explanation, the control unit 120 and the storage unit 110 in FIG. 2 are collectively depicted as the message queuing unit 30).

Conversely, as depicted in FIG. 9, the message queuing server 100 may include the storing application 11 for storing a queue in the message queuing unit 30, and the process performing server 20 having the extracting application may be a physical server as explained in the embodiment above (note also in FIG. 9 that, for easy explanation, the control unit 120 and the storage unit 110 in FIG. 2 are collectively depicted as the message queuing unit 30).

Still further, in the present embodiment, the storage unit 110 is incorporated in the message queuing server 100. This is not meant to be restrictive. For example, a network storage, such as Network Attached Storage (NAS) or Storage Area Network (SAN), may be used.

Still further, all or arbitrary part of the process functions performed in each component can be achieved by a CPU and a program analyzed and executed on that CPU, or can be achieved as hardware with a wired logic.

### EXAMPLE

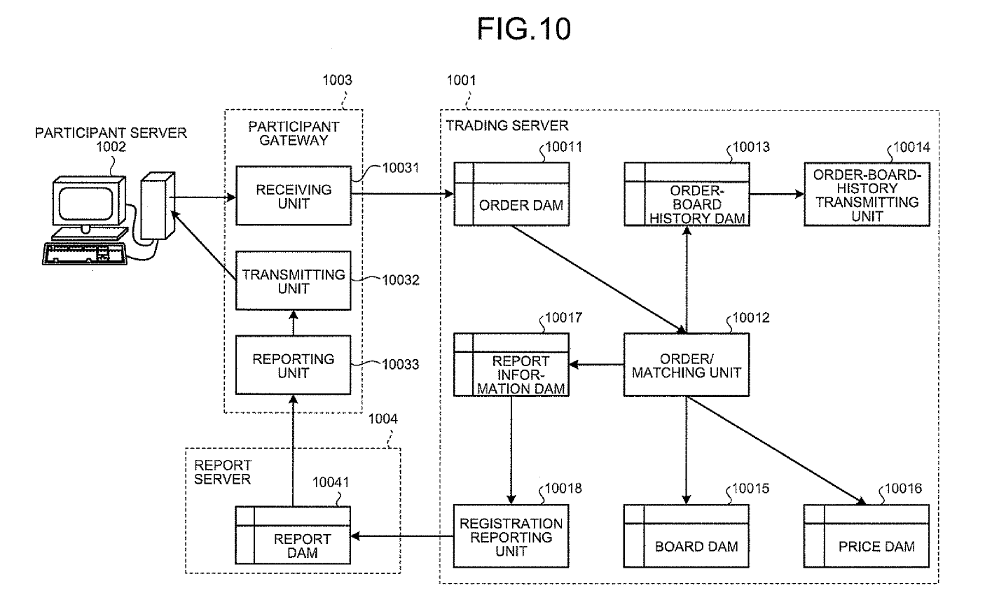

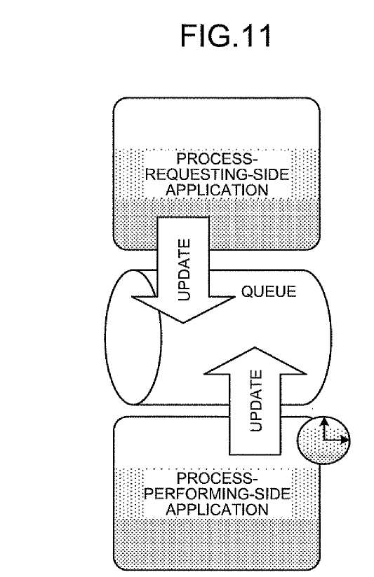

An example in a stock exchange system is explained below. FIG. 10 is a system configuration diagram when an application linkage control system of the present invention is applied to a stock exchange system.

First, 1001 denotes a trading server for stock exchanging process, and an order DAM 10011, an order-board history DAM 10013, a board DAM 10015, a price DAM 10016, and a report information DAM 10017 correspond to the message queuing server 100 explained in the embodiments above.

An order/matching unit 10012, an order-board-history transmitting unit 10014, and a registration reporting unit 10018 correspond to the process-requesting-side application or the process-performing-side application explained in the embodiments above.

For example, the order/matching unit 10012 obtains and executes an order from the order DAM 10011 having accumulated therein order request information received from a receiving unit 10031 of a participant gateway 1003, which will be explained further below. That is, the receiving unit 10031 serves as a process-requesting-side application. On the other hand, the order/matching unit 10012 serves as a process-requesting-side application for the order-board-history transmitting unit 10014 from the correspondence with the order-board history DAM 10013 as a message queuing server.

1003 denotes the participant gateway, including the receiving unit 10031 that transfers to the trading server 1001 information about reception of an order from a participant server 1002 for participants in stock exchange, a reporting unit 10033 that sends various reports to the participant server 1002, and a transmitting unit 10032.

As explained above, an output from the receiving unit 10031 of the participant gateway is queued in the order DAM 10011 of the trading server 1001, and that information is processed by the order/matching unit 10012.

1004 denotes a report server, including a report DAM 10041 that queues a registration report from the registration reporting unit 10018 of the trading server 1001 and sends the queued report information to the reporting unit 10033 of the participant gateway 1003.

Here, as mentioned in the explanation of the order/matching unit 10012 of the trading server 1001, the order DAM 10011, the order-board history DAM 10013, the board DAM 10015, the price DAM 10016, the report information DAM 10017, and the report DAM 10041 perform processes similar to those explained in the embodiments above. Also, the processing unit preceding to each DAM has a function of a process-requesting-side application, whilst the processing unit subsequent to each DAM has a function of a process-performing-side application.

In such processes, as for an order request from the participant server 1002, an order-complete report arrives via many applications, that is, a receiving unit 1031, the order/matching unit 10012, the registration reporting unit 10018, the reporting unit 10033, and the transmitting unit 10032. However, in the present embodiments, each process is performed as event-driven via each of the DAMs (the order DAM 10011, the report information DAM 10017, and the report DAM 10041). Therefore, the process of completing an order can be performed at high speed even via a plurality of applications.

According to the present invention, an effect can be achieved such that process latency occurring from the time when a message is stored in a queue to the time when the message is extracted therefrom can be solved to increase process performance of a distributed system connected via the queue.

Also, according to the present invention, an effect can be achieved such that the transmission-destination application can be operated only when a transaction process by the transmission-source application has been successfully completed, thereby efficiently operating the transmission-destination application.

Furthermore, according to the present invention, when reference to the processed messages is required, a special database for retaining these processed messages, which is conventionally required, is not required. By using an index, the messages accumulated in the queue can be easily referred to. With this, an effect can be achieved such that it is possible to increase process performance when a process accompanied by reference to processed or unprocessed messages is to be performed.

Still further, according to the present invention, processes regarding provision of serial numbers, which are conventionally performed individually when the transmission-source application transmits a message, can be unified, and a bottleneck due to exclusive control in discharging a serial number can be solved. Thus, an effect can be achieved such that process performance of the distributed system connected via the queue can be further increased.

Still further, according to the present invention, when the frequency of storing a message in the queue is higher than the frequency of extracting a message from the queue, a process regarding provision of a serial number can be performed at distributed timings. Thus, an effect can be achieved such that process performance of the distributed system connected via the queue can be further increased.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer readable storage medium containing instructions for controlling a linkage operation among applications by using a queue having accumulated therein messages transmitted and received asynchronously among the applications, wherein the instructions, when executed by a computer, cause the computer to perform:
storing in the queue a message transmitted from a transmission-source application; and
controlling a linkage operation between the transmission-source application and a transmission-destination application by transmitting, to the transmission-destination application, information regarding the message stored in the queue.

2. The computer readable storage medium according to claim 1, wherein
the controlling includes, after the message is stored in the queue, when commit information indicating that a series of task processes accompanied by transmission of the message has been established is transmitted from the transmission-source application, transmitting the information regarding the message to the transmission-destination application.

3. The computer readable storage medium according to claim 1, the instructions further cause the computer to perform providing, after the message is stored in the queue, a serial number indicating an order of storing in the queue to the message.

4. The computer readable storage medium according to claim 3, wherein
at the message serial-number providing step, when a message accumulated in the queue is extracted, a serial number indicating an order of storing in the queue is provided to the message.

5. A computer readable storage medium containing instructions for controlling a linkage operation among applications by using a queue having accumulated therein messages transmitted and received asynchronously among the applications, wherein the instructions, when executed by a computer, cause the computer to perform:
storing in the queue a message transmitted from a transmission-source application, with a predetermined item contained in the transmitted message being set as an index; and
controlling a linkage operation between the transmission-source application and a transmission-destination application by transmitting, to the transmission-destination application, the message stored in the queue, and, when designation of the item set as the index is accepted, outputting a message corresponding to the designated item.

6. The computer readable storage medium according to claim 5, the instructions further cause the computer to perform providing, after the message is stored in the queue, a serial number indicating an order of storing in the queue to the message.

7. The computer readable storage medium according to claim 6, wherein
the providing includes, when a message accumulated in the queue is extracted, providing a serial number indicating an order of storing in the queue to the message.

8. A method of controlling a linkage operation among applications by using a queue having accumulated therein messages transmitted and received asynchronously among the applications, the method comprising:
storing in the queue a message transmitted from a transmission-source application, with a predetermined item contained in the transmitted message being set as an index; and
controlling a linkage operation between the transmission-source application and a transmission-destination application by transmitting, to the transmission-destination application, the message stored in the queue, and when designation of the item set as the index is accepted, outputting a message corresponding to the designated item.

9. The method according to claim 8, further comprising providing, after the message is stored in the queue, a serial number indicating an order of storing in the queue to the message.

10. The method according to claim 9, wherein
the providing includes, when a message accumulated in the queue is extracted, providing a serial number indicating an order of storing in the queue to the message.
